(19) United States
(12) Patent Application Publication
(10) Pub. No.: US 2025/0294451 A1
(43) Pub. Date: Sep. 18, 2025

(54) POSITIONING REFERENCE SIGNAL RECEPTION IN SIDELINK COMMUNICATIONS

(71) Applicant: TOYOTA JIDOSHA KABUSHIKI KAISHA, Toyota-shi, Aichi-ken (JP)

(72) Inventors: Ling YU, Kauniainen (FI); Torsten WILDSCHEK, Gloucester (GB); Taylan SAHIN, Munich (DE); Stepan KUCERA, Munchen (DE); Takayuki SHIMIZU, Mountain View, CA (US)

(73) Assignee: TOYOTA JIDOSHA KABUSHIKI KAISHA, Toyota-shi, Aichi-ken (JP)

(21) Appl. No.: 18/860,650

(22) PCT Filed: Apr. 26, 2023
(86) PCT No.: PCT/JP2023/016505

§ 371 Date: Oct. 26, 2024

Related U.S. Application Data
(60) Provisional application No. 63/335,601, filed on Apr. 27, 2022.

(51) Int. Cl. H04W 52/02; H04W 72/25

(52) U.S. Cl. CPC H04W 52/0219; H04W 52/0216; H04W 72/25

(57) ABSTRACT

A method for a user equipment in a sidelink communication. The method includes: waking up the user equipment by a configuration or preconfiguration of one or more power-on parameters of the user equipment, wherein the one or more power-on parameters are utilized for performing sidelink communications with one or more additional user equipment, and wherein the one or more power-on parameters include a default time for waking up that is predetermined by the user equipment and at least one additional time for waking up based on a determination by the user equipment or a request by the one or more additional user equipment; and after waking up the user equipment, receiving, by the user equipment, one or more sidelink signals from the one or more additional user equipment.

### CROSS REFERENCES TO RELATED APPLICATIONS

This application is a national phase of International Application No. PCT/JP2023/016505, filed Apr. 26, 2023, which claims the benefit of U.S. Provisional Application No. 63/335,601, which was filed on Apr. 27, 2022. The entire contents of the above referenced applications are incorporated herein by reference.

### TECHNICAL FIELD

This invention relates to a method for using a user equipment in a sidelink communication, an apparatus for using in a sidelink communication and a non-transitory computer-readable medium.

### BACKGROUND ART

Generally described, computing devices and communication networks can be utilized to exchange information. In a common application, a computing device can request/transmit data with another computing device via the communication network. More specifically, computing devices may utilize a wireless communication network to exchange information or establish communication channels.

Wireless communication networks can include a wide variety of devices that include or access components to access a wireless communication network. Such devices can utilize the wireless communication network to facilitate interactions with other devices that can access the wireless communication network or to facilitate interaction, through the wireless communication network, with devices utilizing other communication networks. In addition or alternatively, devices can communicate directly between each other without going through the wireless communication network, or without utilizing the wireless communication network, at some times or all times.

In the context of vehicles or other mobile apparatus, communication networks can be configured to provide communication among vehicles (or integrated components) which are equipped with wireless interfaces. There are numerous approaches to implement such wireless communication network, such as in the 802.xx air interfaces promulgated by the Institute of Electrical and Electronics Engineer (“IEEE”). Another approach to such wireless communication networks corresponds to cellular-based communication networks, specifically, the New Radio (NR) and its capability to support Sidelink (SL) communication.

### SUMMARY OF INVENTION

The present invention in its first aspect provides a method for using a user equipment in a sidelink communication, the method comprising: waking up the user equipment by a configuration or pre-configuration of one or more power-on parameters of the user equipment, wherein the one or more power-on parameters are utilized for performing sidelink communications with one or more additional user equipment, and wherein the one or more power-on parameters include a default time for waking up that is predetermined by the user equipment and at least one additional time for waking up based on a determination by the user equipment or a request by the one or more additional user equipment; and after waking up the user equipment, receiving, by the user equipment, one or more sidelink signals from the one or more additional user equipment.

The present invention in its second aspect provides an apparatus for using in a sidelink communication, the apparatus comprising: a memory storing an instruction; and a processor configured to execute the instruction stored in the memory to: wake up the apparatus by a configuration or pre-configuration of one or more power-on parameters of the apparatus, wherein the one or more power-on parameters are utilized for performing sidelink communications with one or more additional apparatuses, and wherein the one or more power-on parameters include a default time for waking up that is predetermined by the apparatus and at least one additional time for waking up based on a determination by the apparatus or a request by the one or more apparatuses; and after waking up the apparatus, receiving, by the apparatus, one or more sidelink signals from the one or more additional apparatuses.

The present invention in its third aspect provides a non-transitory computer-readable medium storing instructions that are executable by one or more processors of an apparatus to perform a method, the method comprising: waking up the apparatus by a configuration or preconfiguration of one or more power-on parameters of the apparatus, wherein the one or more power-on parameters are utilized for performing sidelink communications with one or more additional apparatuses, and wherein the one or more power-on parameters include a default time for waking up that is predetermined by the apparatus and at least one additional time for waking up based on a determination by the apparatus or a request by the one or more apparatuses; and after waking up the apparatus, receiving, by the apparatus, one or more sidelink signals from the one or more additional apparatuses.

The present invention in its fourth aspect provides a method for using a network infrastructure device in a sidelink communication, the method comprising: configuring, by the network infrastructure device, one or more power-on parameters for one or more user equipment; and transmitting, by the network infrastructure device, the one or more power-on parameters to the at least one user equipment, wherein the one or more power-on parameters are utilized for waking up the one or more user equipment to receive sidelink signals from one or more additional user equipment.

The present invention in its fifth aspect provides a network infrastructure device for use in a sidelink communication, the network infrastructure device comprising: a memory storing an instruction; and a processor configured to execute the instruction stored in the memory to: configure, by the network infrastructure device, one or more power-on parameters for one or more user equipment; and transmit, by the network infrastructure device, the one or more power-on parameters to the at least one user equipment, wherein the one or more power-on parameters are utilized for waking up the one or more user equipment to receive sidelink signals from one or more additional user equipment.

The present invention in its sixth aspect provides a non-transitory computer-readable medium storing instructions that are executable by one or more processors of a network infrastructure device to perform a method, the method comprising: configuring, by the network infrastructure device, one or more power-on parameters for one or more user equipment; and transmitting, by the network infrastructure device, the one or more power-on parameters to the at least one user equipment, wherein the one or more power-on parameters are utilized for waking up the one or more user equipment to receive sidelink signals from one or more additional user equipment.

The present invention in its seventh aspect provides a method for using an anchor device in a sidelink communication, the method comprising: obtaining, by the anchor device, one or more power-on parameters to wake up one or more user equipment, wherein the one or more power-on parameters include a default time for waking up and at least one additional time for waking up obtained by the anchor device, and wherein obtaining the one or more power-on parameters by the anchor device comprises receiving the one or more power-on parameters by the anchor device from a network infrastructure device or pre-configuring the one or more power-on parameters by the anchor device; and transmitting, by the anchor device, according to the obtained one or more power-on parameters, sidelink signals to the one or more user equipment.

The present invention in its eighth aspect provides an anchor device for use in a sidelink communication, the anchor device comprising: a memory storing an instruction; and a processor configured to execute the instruction stored in the memory to: obtain, by the anchor device, one or more power-on parameters to wake up one or more user equipment, wherein the one or more power-on parameters include a default time for waking up and at least one additional time for waking up obtained by the anchor device, and wherein obtaining the one or more power-on parameters by the anchor device comprises receiving the one or more power-on parameters by the anchor device from a network infrastructure device or pre-configuring the one or more power-on parameters by the anchor device; and transmit, by the anchor device, according to the obtained one or more power-on parameters, sidelink signals to the one or more user equipment.

The present invention in its nineth aspect provides a non-transitory computer-readable medium storing instructions that are executable by one or more processors of an anchor device to perform a method, the method comprising: obtaining, by the anchor device, one or more power-on parameters to wake up one or more user equipment, wherein the one or more power-on parameters include a default time for waking up and at least one additional time for waking up obtained by the anchor device, and wherein obtaining the one or more power-on parameters by the anchor device comprises receiving the one or more power-on parameters by the anchor device from a network infrastructure device or pre-configuring the one or more power-on parameters by the anchor device; and transmitting, by the anchor device, according to the obtained one or more power-on parameters, sidelink signals to the one or more user equipment.

### BRIEF DESCRIPTION OF DRAWINGS

Various features will now be described with reference to the following drawings. Throughout the drawings, reference numbers may be re-used to indicate correspondence between referenced elements. The drawings are provided to illustrate examples described herein and are not intended to limit the scope of the disclosure.

FIG. 1 is a block diagram depicting an exemplary communication system, consistent with some embodiments of the present application.

FIG. 2A depicts one embodiment of an architecture of an illustrative Road Side Unit (RSU) for implementing one or more aspects of the present application.

FIG. 2B depicts one embodiment of an architecture of an illustrative User Equipment (UE) for implementing one or more aspects of the present application.

FIG. 2C depicts one embodiment of an architecture of an illustrative Next Generation Node B (gNB) for implementing one or more aspects of the present application.

FIG. 3A is a block diagram of the architecture of FIG. 1 illustrating the configuration of PRS signals in accordance with sidelink-based communications.

FIG. 3B is a block diagram of the architecture of FIG. 1 illustrating the configuration of PRS signals in accordance with sidelink-based communications.

FIG. 4 is a block diagram of the architecture of FIG. 1 illustrating the configuration of Positioning Reference Signal (PRS) signals in accordance with sidelink-based communications.

FIG. 5 is a block diagram of the architecture of FIG. 1 illustrating the configuration of PRS signals in accordance with sidelink-based communications.

FIG. 6 is a flow diagram depicting an example routine for PRS resource pool parameter configuration implemented by a user equipment in accordance with aspects of the present application.

### DESCRIPTION OF EMBODIMENTS

Generally described, one approach to the exchange of positioning information and/or signals includes deploying a set of one or more devices along roads or other areas of transmit which can communicate with mobile UEs. Illustratively, the devices that transmit Positioning Reference Signal (PRS) can correspond to one or more device(s), which may be generally referred to as roadside units (“RSUs”), “anchors,” or “UEs”. Reference to RSUs or anchors throughout the present application is not intended to be limiting in any manner to configuration of any particular device or difference in functionality and should be considered interchangeable unless expressly described. Illustratively, RSUs are not considered mobile in nature (e.g., a permanent or semi-permanent location) and their locations can be easily acquired. For positioning by employing either timing-based (e.g., time difference of arrival (TDOA) or round-trip transmission (RTT)) or angle-based methods, transmissions of positioning reference signals (PRSs) from RSUs or/and from UEs are used for positioning relevant measurements.

To achieve positioning over the SL radio interface, UEs need to transmit/receive certain reference signals for positioning different from SL communication data, referred to generally as “SL positioning reference signals” (SL PRS). UEs conduct certain measurements (e.g., time of arrival, angle of arrival, etc.) on transmitted reference signals, which are then used to calculate individual position estimates. For purposes of illustration, components or entities that assist positioning this UE, e.g., by sending/receiving SL PRS, will be referred to as anchors. Aspects of the present application are described with regard to anchors being specific computing devices configured, at least in part, to provide positioning signals, such as SL PRS. Additionally, other UEs or devices or network entities supporting SL functionality, may also function as anchors for purposes of positioning. SL PRS can be configured in terms of various parameters including time-frequency resources, such as bandwidth and periodicity; directivity-related parameters such as beam direction, beam width, number of beams, etc.; and transmit power.

Aspects of the present application are described with regard to anchors being specific computing devices configured, at least in part, to provide positioning information, such as RSUs. Additionally, other UEs or devices and network entities supporting SL functionality, such as other UEs may also function as anchors for purposes of positioning. SL PRS can be configured in terms of various parameters including time-frequency resources, such as bandwidth and periodicity; directivity-related parameters such as beam direction, beam width, number of beams, etc.; and transmit power.

Design of PRS transmission is essential for the performance of positioning in term of positioning accuracy, resource efficiency, power consumption, and positioning latency etc. Traditional SL design in either Long-Term Evolution (LTE) or NR typically requires the SL receiving (Rx) UE to monitor all configured Rx resource pools for blind detection of SL control information (SCI) over physical SL control channel (PSCCH) and then receive SL data transmitted over physical SL shared channel (PSSCH) according to detected SCI. This mechanism is considered a rather energy consuming process. Therefore, UEs with limited energy capacity (e.g., potential resources for operation of a device) can perform SL transmission only without mandatory SL reception and SL transmission with partial SL reception in Rel-14 LTE SL design and Rel-17 NR SL design for energy saving.

Typical methods for SL based ranging and positioning require reception of SL information from UEs. For example, SL-based ranging and positioning computation may be performed in equipment that may be characterized as vulnerable road users (VRU) (e.g., pedestrians, cyclists, motorcyclists, etc.) devices or the vehicle devices or anchors in proximity of VRU devices. Such SL-based communications may be facilitated using Multi-RTT Positioning method. Illustratively, the UEs need to receive either PRS from vehicle devices or RSUs/anchors, or the request for activating PRS transmissions. In another example, when SL-based ranging and positioning is performed using positioning methods of SL-AOD, SL-TDOA or SL-AoA, the UEs need to receive the SL signals from RSUs/anchors for ranging and positioning measurement and computation. Thus, the availability of SL-based communications from UEs is used for various ranging and positioning functionality.

Generally described, for SL-based ranging and positioning, some devices may not be able to typically rely on SL transmission only as the only mechanism to achieve energy efficiency operation or energy resource savings. An additional mechanism on energy efficient reception of SL is needed to allow devices such as VRU devices to receive SL ranging and positioning related transmissions in an energy efficient way. Illustratively, reference to energy efficiency may relate to management of energy resources, such as battery cells, that are utilized for operation of devices. In this document, the terms energy limited device(s) and power limited device(s) may be used interchangeably.

Generally described, SL Discontinuous Reception (DRX) for broadcast, groupcast and unicast has been supported in various air/radio interfaces as energy saving mechanism for SL reception. However, in such approaches, for SL ranging and positioning, only the PRSs need to be transmitted and received time to time between devices, e.g., VRU devices, and other relevant devices, e.g., vehicle devices or RSUs/anchors, in proximity. The signaling procedures and information exchange for establishment of SL unicast connection may already introduce unnecessary energy consumption to devices. Thus, such approaches are not considered as energy consumption friendly solution for support of SL ranging and positioning.

To address, at least in part, the deficiencies described above, one or more aspects of the present application correspond to a framework for targeted SL ranging and positioning specific configurations. More specifically, aspects correspond to a SL ranging and positioning (RP) specific receiver (Rx) ON time (expressed as SL-RP_Rx-ON) for devices to wake-up to receive SL ranging and positioning related signals. Illustratively, the framework can correspond to a lightweight mechanism to configure SL-RP Rx-ON related parameters to devices and other devices in their proximity. Additionally, under one or more aspects of the present application, the system and methods implemented do not require any of the signaling exchange between relevant devices to synchronize SL-RP_Rx-On parameters or the required information exchange embedded into the SL transmission of devices. Thus, in accordance with aspects of the present application, energy consumption is minimized on signaling exchange of SL-RP_Rx-ON parameters for the devices.

In accordance with the first embodiment, a static SL-RP_Rx-ON time related parameter pre-configuration or configuration is associated with SL resource pool configuration. Illustratively, reference to configuration, pre-configuration, or (pre-)configuration is not intended to be limiting to any particular arrangement and should be construed as inclusive of various embodiments. Individual SL resource pool is configured with the static SL-RP_Rx-ON parameter so that any SL ranging and positioning relevant UEs know when to expect devices to wake-up for SL ranging and positioning reception based on corresponding SL resource pool configuration. Such processes may be further applicable to energy-limited devices. Additionally, this embodiment can be extended to support multiple SL-RP_Rx-ON parameter (pre-)configurations. The different (pre-)configurations may be associated with the same SL resource pool (meaning one resource pool has one or more set(s) of SL-RP_Rx-ON parameter(s)) or different SL resource pools (meaning each resource pool has one set of SL-RP_Rx-ON parameter(s) and different resource pools may be associated with the same or different set of SL-RP_Rx-ON parameter(s)). By way of illustrative example, one of the one or more SL-RP_Rx-ON parameter set(s) may be (pre-)configured as the default one, of which, for example, all power limited devices will wake up for SL reception accordingly. The other SL-RP_Rx-ON parameter set(s) (pre-)configuration may be activated to one set of device(s) by the activation indication from another set of device(s) and the activation indication is transmitted using the default SL-RP_Rx-ON (pre-)configuration. However, one skilled in the relevant art should not consider the examples as limiting.

In accordance with a second embodiment, instead of static SL-RP_Rx-ON configuration(s) on per SL resource pool basis as in the first embodiment, the SL-RP_Rx-ON related configuration may indicate the offset between SL transmission of a set of device(s) (e.g., periodic SL transmission of VRU devices' CAM or DEMN messages) and SL-RP Rx-ON time. Based on the SL-RP_Rx-ON offset configuration, device wakes up for SL reception after the configured offset time when it transmits the SL communication (e.g., CAM or DEMN message). Another set of device(s), upon receiving SL transmission from a device in the first set, also know(s) when device(s) from the first set will wake up for SL reception based on the configured offset.

In accordance with a third embodiment, instead of (pre-)configured SL-RP_Rx-ON offset configuration as in the second embodiment, device(s) (e.g., VRU devices) may indicate the offset of SL-RP_Rx-ON time in the SL transmission of its own. That is, the device(s) indicate(s) the offset of wake-up time for SL reception towards its current SL transmission.

Although aspects of the present application will be described with regard to illustrative network components, interactions, and routines, one skilled in the relevant art will appreciate that one or more aspects of the present application may be implemented in accordance with various environments, system architectures, computing device architectures and the like. Similarly, reference to specific devices, such as RSUs, UEs, gNBs, can be considered to be general references and not intended to provide additional meaning or configurations for individual computing devices. In further embodiments, besides the vehicular/pedestrian/cyclist UEs, the UE can be also an Internet of Things (IoT) or a commercial device with SL functionality, that needs to be positioned via SL, considering many different use cases that SL positioning needs to support. Additionally, reference to any specific types of data types, structures or interfaces are also intended solely for purposes of illustration and should not be construed as limiting. Accordingly, all examples are intended to be illustrative in nature and should not be construed as limiting.

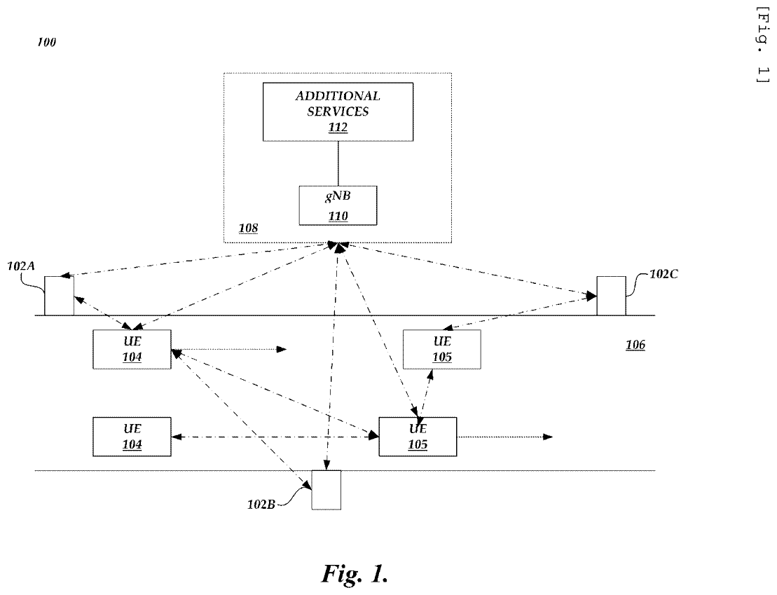

FIG. 1 depicts a block diagram of an exemplary communication system (environment) 100 for implementing one or more aspects of the present application. The environment 100 can comprise a first set of device(s) 102 (e.g., 102A, 120B) corresponding to RSUs that are located at fixed locations, such as defined locations along a transit area 106 (e.g., road or path). The environment 100 includes a second set of device(s) 104 (e.g., 104A, 104B) corresponding to UE(s) that are/is configured to be dynamically in motion, for example, along the transit area 106. In some embodiments, the RSU(s) 102 and UE(s) 104 may be in wireless communication with a gNB 110 of an network infrastructure device 108, for example, RSU(s) 102 and the UE(s) 104 may be in a full-coverage or partial-coverage area of the wireless signals from the gNB 110. In some embodiments, the RSU(s) 102 and the UE(s) 104 may not be in wireless communication with the gNB 110, for example, the RSU(s) 102 and the UE(s) 104 may be in an out-of-coverage area of the wireless signals from the gNB 110. The RSU(s) 102 and UE(s) 104 can also be in wireless communication with one or more additional components 112 of the network infrastructure device 108 that can offload processing of information or functionality associated with the wireless network, such as the gNB 110 and a location service (LCS) server (not shown). The gNB and LCS server can be connected to the one or more additional components 112.

The communication between the gNB 110 and the RSU(s) 102 and UE(s) 104 may correspond to a Radio Access Network (RAN), such as a Next Generation RAN (NG-RAN). Other examples of RAN and core network may be implemented without departing from the scope of this disclosure. Other examples of RAN include Evolved Universal Terrestrial Radio Access Network (EUTRAN), Universal Terrestrial Radio Access Network (UTRAN), and additional variations or alternatives (e.g., 3GPP 6G Radio Access Network).

The RAN illustratively implements a Radio Access Technology (RAT), such as a New Radio (NR), Long Term Evolution (LTE) also known as Evolved Universal Terrestrial Radio Access (EUTRA), Universal Mobile Telecommunication System (UMTS), etc. The RAT of the example system of environment 100 may illustratively be NR. Different names for the RAN nodes may be used, for example depending on the RAT used for the RAN. For the illustrative example of the system of mobile communications 100 in FIG. 1, the nodes of an NG-RAN 105 may be either a next generation Node B (gNB) 110 or a next generation evolved Node B (ng-eNB). In other applications, a RAN node may be referred to as Node B (NB) in a RAN that uses the UMTS RAT. A RAN node may be referred to as an evolved Node B (eNB) in a RAN that uses LTE/EUTRA RAT. However, as indicated above, the terms base station, RAN node, eNB, gNB and ng-eNB may be used interchangeably. Additionally, reference to the network infrastructure device 108 may be used to reference the RAN node and additional core network equipment corresponding to a wireless network.

Illustratively, the various aspects associated with the network infrastructure device 108 (gNB 110) can be implemented as one or more components that are associated with one or more function(s) or service(s). The components may correspond to software modules implemented by one or more computing device(s), which may be a separate stand-alone computing device. Accordingly, the components of gNB 110 should be considered as a logical representation of the service, not requiring any specific implementation on one or more computing devices. Additionally, the infrastructure equipment (including any additional equipment not illustrated) may be maintained by an operator such as a Mobile Network Operator (MNO), a private network operator, a Multiple System Operator (MSO), an Internet of Things (IoT) network operator, etc., and may offer services such as voice, data (e.g., wireless Internet access), messaging, vehicular communications services such as Vehicle to Everything (V2X) communications services, safety services, mission critical service, services in residential, commercial or industrial settings such as IoT, industrial IOT (IIOT), etc.

With continued reference to FIG. 1, illustratively the RSU(s) 102, UE(s) 104 and UE(s) 105 can exchange information and/or signals, such as positioning signals, in accordance with a sidelink communication channel. Illustratively, the sidelink communication channel can correspond to NR SL, which is a physical layer composed of several physical channels and signals. The SL physical channels are a set of resource elements carrying information of higher layers of the protocol stack. The SL physical channels can include the Physical Sidelink Broadcast Channel (PSBCH) that carries the SL-BCH transport channel where the Master Information Block (MIB) for SL is sent periodically and comprises system information for UE-to-UE or UE-to-RSU communication. The PSBCH is transmitted along with the Sidelink Primary Synchronization Signal/Sidelink Secondary Synchronization Signal (S-PSS/SSS) in the S-SSB (synchronization signal block signals). The SL physical channels can further include a Physical Sidelink Feedback Channel (PSFCH) that is used to transmit the HARQ feedback from a receiver UE/RSU to the transmitter UE on the SL for a unicast or groupcast communication. The SL physical channels can also include a Physical Sidelink Shared Channel (PSSCH) and Physical Sidelink Control Channel (PSCCH). Individual PSSCH, contains transport blocks associated with a PSCCH. The PSCCH is transmitted on the same slot as PSSCH and contains control information about the shared channel. The Sidelink Control Information (SCI) is split into two stages. The 1st stage is sent on PSCCH, which is associated with a PSSCH, and the 2nd stage is sent over the corresponding PSSCH. Demodulation Reference Signal (DMRS) is used for PSCCH, PSSCH, and PSBCH as reference signals for demodulation of messages in a receiver.

The UE(s) 104 and UE(s) 105 may include wireless transmission and reception components for communications with one or more node(s) in the RAN, one or more relay node(s), or one or more other UE(s), etc. Examples of UEs include, but not limited to, are smartphones, tablets, laptops, computers, wireless transmission and/or reception units in a vehicle, V2X or Vehicle to Vehicle (V2V) devices, wireless sensors, internet of things (IoT) devices, industrial internet of things (IIOT) devices, etc. Other names may be used for UEs such as a Mobile Station (MS), terminal equipment, terminal node, client device, mobile device, etc. Still further, UEs 104 may also include components or subcomponents integrated into other devices, such as vehicles, to provide wireless communication functionality with nodes in the RAN, other UEs, RSUS, satellite communications as described herein. Such other devices may have other functionality or multiple functionalities in addition to wireless communications. Accordingly, reference to UE may include the individual components facilitating the wireless communication as well as the entire device that incorporates components for facilitating wireless communications. As previously discussed, in certain embodiments, UE(s) 105 is/are distinguished based on having relatively finite power sources, such that energy management for signaling is typically implemented.

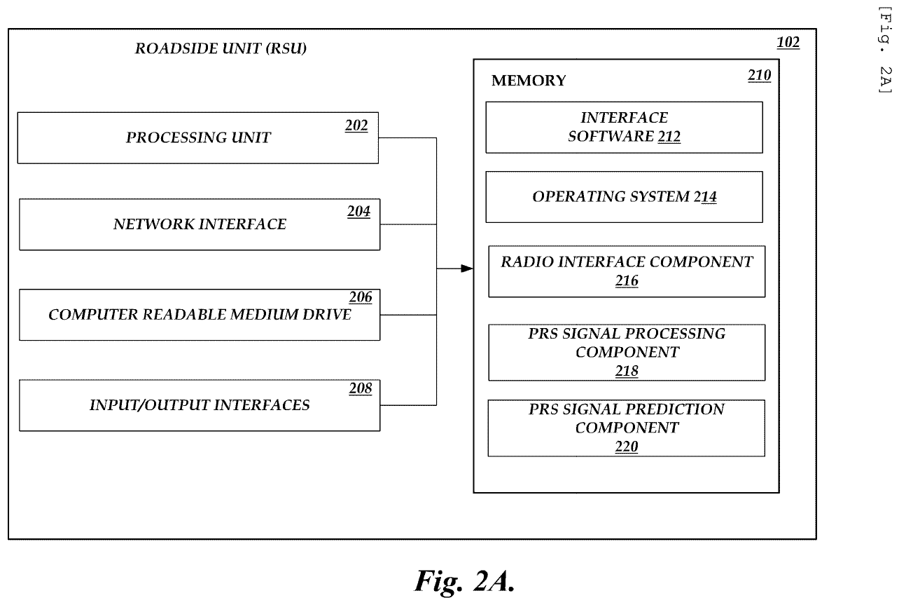

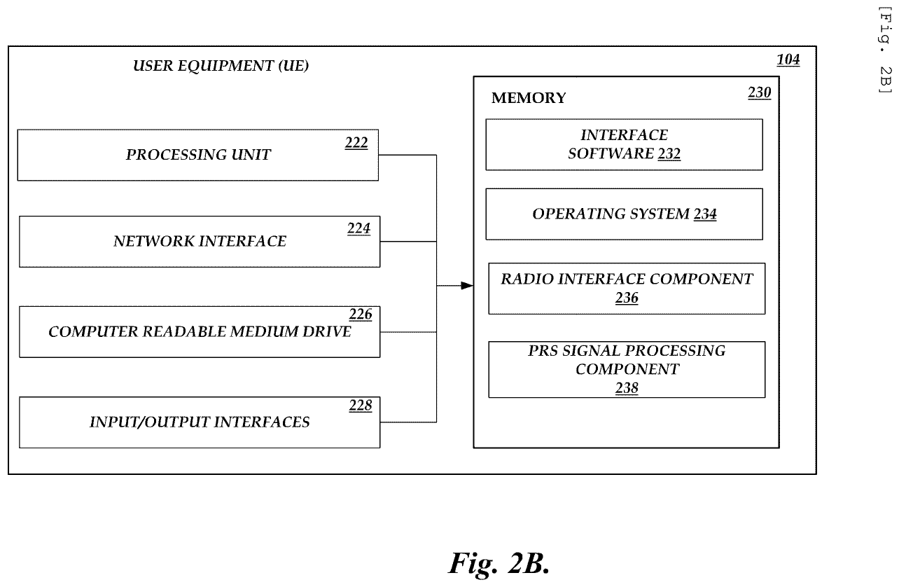

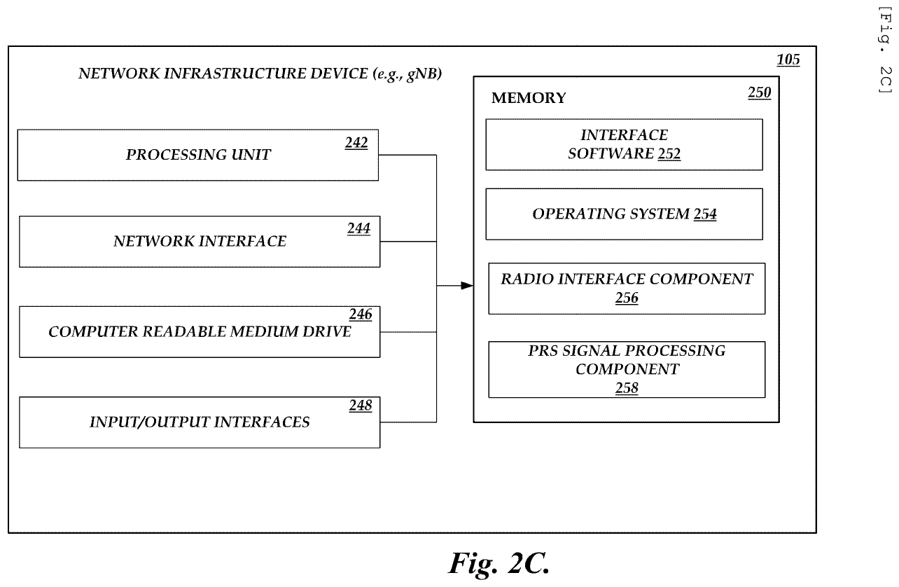

FIG. 2A depicts one embodiment of an architecture of an illustrative RSU 102 (or other anchor) or other network component for implementing one or more aspects of the present application as described. The general architecture of the RSU 102 depicted in FIG. 2A includes an arrangement of computer hardware and software components that may be used to implement aspects of the present disclosure. As previously discussed, the components of the RSU 102 may include physical hardware components, one or more virtualized components, or a combination thereof. Additionally, the components of the RSU 102 or the functionality attributed by the RSU 102 may be implemented in a virtualized environment. Such virtualized environments may be provided by the manufacturer or by a third-party entity, such as a computing service provider that can instantiate software modules that may be persistent or temporary in nature for purposes of implementing the functionality depicted in the illustrative architecture for the RSU 102.

As illustrated, the RSU 102 includes a processing unit 202, a network interface 204, a computer-readable medium drive 206, and an input/output interface 208, all of which may communicate with one another by way of a communication bus. The components of the RSU 102 may be physical hardware components or implemented in a virtualized environment. The network interface 204 may provide connectivity to one or more network(s) or computing system(s), such as the wireless network depicted in FIG. 1. The processing unit 202 may thus receive information and instructions from other computing systems or services via a network. The processing unit 202 may also communicate to and from memory 210 and further provide output information via the input/output interface 208, including via SL physical channels and wireless communication channels. In some embodiments, the RSU 102 may include more (or fewer) components than those shown in FIG. 2A, including one or more antennas for facilitating transmission and receipt of wireless signals.

The memory 210 may include computer program instructions that the processing unit 202 executes in order to implement one or more embodiments. The memory 210 generally includes RAM, ROM, or other persistent or non-transitory memory. The memory 210 may store an operating system 214 that provides computer program instructions for use by the processing unit 202 in the general administration and operation of the RSU 102. The memory 210 may further include computer program instructions and other information for implementing aspects of the present disclosure. For example, in one embodiment, the memory 210 includes a radio interface component 216 for processing wireless signals from the network infrastructure device 108, UE(s) 104 or other RSU(s) 102. The memory 210 includes a PRS information component 218 that is configured to provide PRS information to one or more UE(s) as described herein. The memory 210 may also include a PRS signal prediction component 220 that is configured to predict PRS signal(s). As will be described below, the RSU 102 or other network equipment (e.g., gNB) or pre-configuration can provide SL resource pool parameters according to various embodiments described herein.

FIG. 2B depicts one embodiment of an architecture of an illustrative UE 104 for implementing one or more aspects of the present application as described. As previously indicated, for purposes of illustration, UE 104 may be considered part of a first set of user equipment that may be utilized to configure other UEs (e.g., a second set of user equipment) for SL communications. The general architecture of the UE 104 depicted in FIG. 2B includes an arrangement of computer hardware and software components that may be used to implement aspects of the present disclosure. As previously discussed, the components of the UE 104 may include physical hardware components, one or more virtualized components, or a combination thereof. Additionally, the components of the UE 104 or the functionality attributed by the UE 104 may be implemented in a virtualized environment. Such virtualized environments may be provided by the manufacturer or by a third-party entity, such as a computing service provider that can instantiate software modules that may be persistent or temporary in nature for purposes of implementing the functionality depicted in the illustrative architecture for the UE 104.

As illustrated, the UE 104 includes a processing unit 222, a network interface 224, a computer-readable medium drive 226, and an input/output interface 228, all of which may communicate with one another by way of a communication bus. The components of the feedback UE 104 may be physical hardware components or implemented in a virtualized environment.

The network interface 224 may provide connectivity to one or more network(s) or computing system(s), such as the wireless network depicted in FIG. 1. The processing unit 222 may thus receive information and instructions from other computing system(s) or service(s) via a network. The processing unit 222 may also communicate to and from memory 230 and further provide output information via the input/output interface 228, including via SL physical channels. In some embodiments, the UE 104 may include more (or fewer) components than those shown in FIG. 2B. The memory 230 may include computer program instructions that the processing unit 202 executes in order to implement one or more embodiments. The memory 230 generally includes RAM, ROM, or other persistent or non-transitory memory. The memory 230 may store an operating system 234 that provides computer program instructions for use by the processing unit 222 in the general administration and operation of the UE 104. The memory 230 may further include computer program instructions and other information for implementing aspects of the present disclosure. For example, in one embodiment, the memory 230 includes a radio interface component 236 for processing wireless signals from the network infrastructure device 108, other UE(s) 104 or RSU(s) 102. The memory 230 also includes a PRS signal processing component 238 that is configured to obtain PRS information from one or more RSU(s) 102 and configure SL communication with other UE(s) 105 as described herein.

FIG. 2C depicts one embodiment of an architecture of a network infrastructure device (e.g., the gNB 110 of FIG. 1) for implementing one or more aspects of the present application as described. The general architecture of the gNB depicted in FIG. 2C includes an arrangement of computer hardware and software components that may be used to implement aspects of the present disclosure. As previously discussed, the components of the gNB may include physical hardware components, one or more virtualized components, or a combination thereof. Additionally, the components of the gNB or the functionality attributed by the gNB may be implemented in a virtualized environment. Such virtualized environments may be provided by the manufacturer or by a third-party entity, such as a computing service provider that can instantiate software modules that may be persistent or temporary in nature for purposes of implementing the functionality depicted in the illustrative architecture for the gNB.

As illustrated, the gNB includes a processing unit 242, a network interface 244, a computer-readable medium drive 246, and an input/output interface 248, all of which may communicate with one another by way of a communication bus. The components of the gNB may be physical hardware components or implemented in a virtualized environment, including one or more antennas for facilitating transmission and receipt of wireless signals. The network interface 244 may provide connectivity to one or more network(s) or computing system(s), such as the wireless network depicted in FIG. 1. The processing unit 242 may thus receive information and instructions from other computing system(s) or service(s) via a network. The processing unit 242 may also communicate to and from memory 250 and further provide output information via the input/output interface 248. In some embodiments, the gNB may include more (or fewer) components than those shown in FIG. 2C.

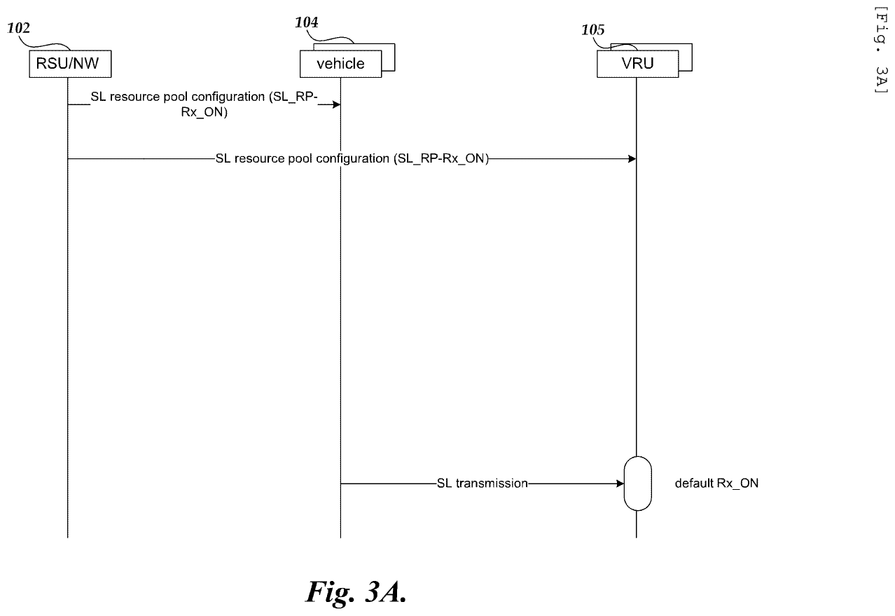

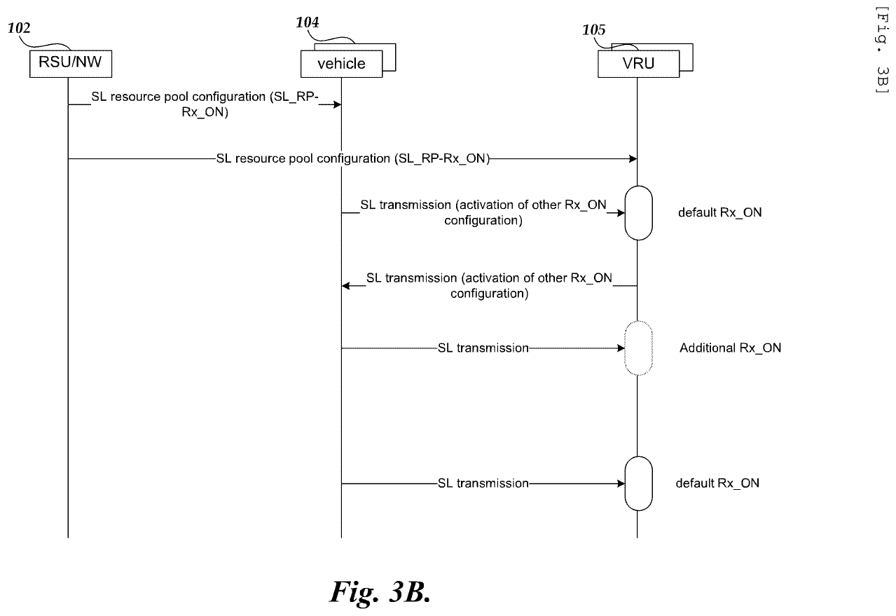

The memory 250 may include computer program instructions that the processing unit 242 executes in order to implement one or more embodiments. The memory 250 generally includes RAM, ROM, or other persistent or non-transitory memory. The memory 250 may include interface software 252. The memory 250 may include an operating system 254 that provides computer program instructions for use by the processing unit 242 in the general administration and operation of the gNB. The memory 250 may include a radio interface component 256. The memory 250 may further include computer program instructions and other information for implementing aspects of the present disclosure. For example, in one embodiment, the memory 250 includes a PRS signal processing component 258 that is configured to provide PRS configuration information to one or more UE(s) 104 and one or more RSU(s) 102 as described herein. FIG. 3A is a block diagram of the architecture of FIG. 1 illustrating the configuration of PRS signals in accordance with sidelink-based communications. As previously described, in this embodiment, the static SL-RP_Rx-ON time related parameter configuration is configured to the power limited devices (e.g., UE(s) 105 in the second set of UE(s)) as part of SL Rx resource pool (pre-)configuration. To ensure the other device(s) have the same configuration, the other device(s) (e.g., UE(s) 104 in the first set of UE(s)) may get the same SL Rx resource pool configuration and determine the transmission time to the power limited devices accordingly. FIG. 3A illustrates a first variation of the first embodiment in which power-on parameter is transmitted from a RSU 102/gNB 110 directly to the UE 105. The transmitted power-on parameter may be a default power-on parameter that is common to the entire set of UE(s) in the second set of UE(s) (e.g., a set of lower power UEs). Any other devices (such as UE(s) in the first set of user equipment) when need of transmitting SL ranging and positioning related information (e.g., either SL-PRS or the request of sending SL-PRS) to power limited devices (e.g. VRU), transmit the initial information only using the default SL-RP_Rx-ON time associated with the corresponding SL Rx resource pool.

FIG. 3B is a block diagram of the architecture of FIG. 1 illustrating the configuration of PRS signal(s) in accordance with a second variation of sidelink-based communications. In some embodiments, the RSU 102/gNB 110 or pre-configuration may configure one or more power-on parameter(s) such that one or more UE(s) 104 may activate alternative power-on parameters based on different criteria. Illustratively, a set of recipient device(s) (e.g., the first set of device(s) 104 and/or the second set of device(s) 105) may be (pre-)configured in the corresponding SL Tx resource pool configuration (assuming there is one-to-one or many-to-one mapping between SL Tx resource pool(s) and Rx resource pool) for the aligned SL-RP Rx-ON time related parameters.

In case of multiple SL-RP_Rx-ON parameter set configuration, the activation of other SL-RP_Rx-ON may be initiated either by other relevant devices (e.g., UE(s) 104) or e.g., by one or more energy limited device(s). As previously described, for illustrative purposes, reference to energy limited devices can include devices with limited energy capacity such as battery-driven equipment (e.g., UE(s) 105). The device(s) may initiate the other relevant device(s) based on detection of congestion in the default Rx-ON period or detection of distance/range related trigger(s). In one example, the other device(s) may detect congestion of vehicles/UEs during the default Rx-ON period. The detection of congestion may be illustratively based on SL sensing result or SL Channel Busy Ratio (CBR) measurement. Based on application of threshold(s) or other information, the other device(s) may be (pre-)configured with process rule(s) or selection criterion/criteria that determines when to select an alternative power-on parameter and/or what alternative power-on parameter to select. In another example, the other device(s) may detect the distance/range towards to the power limited device(s) becomes shorter. In this example, the other device(s) may trigger the activation of additional SL-RP_Rx-ON configuration to the power limited device(s), such as by application of threshold(s) for individual UE(s) 105, types of UEs, grouping of UEs, and the like.

Illustratively, the other devices, such as UE(s) 104, may provide an activation indication that can be transmitted together with SL transmission that the other device(s) sends to the energy/power limited device(s) in the default Rx-ON period. In either case, the activation indication may be specified using either 1st stage SCI or using 2nd stage SCI or MAC CE or information in PSFCH or a part of SL data payload to indicate also which SL-RP_Rx-ON parameter set is to be activated. The activation indication may be transmitted either using SL unicast or SL groupcast or broadcast.

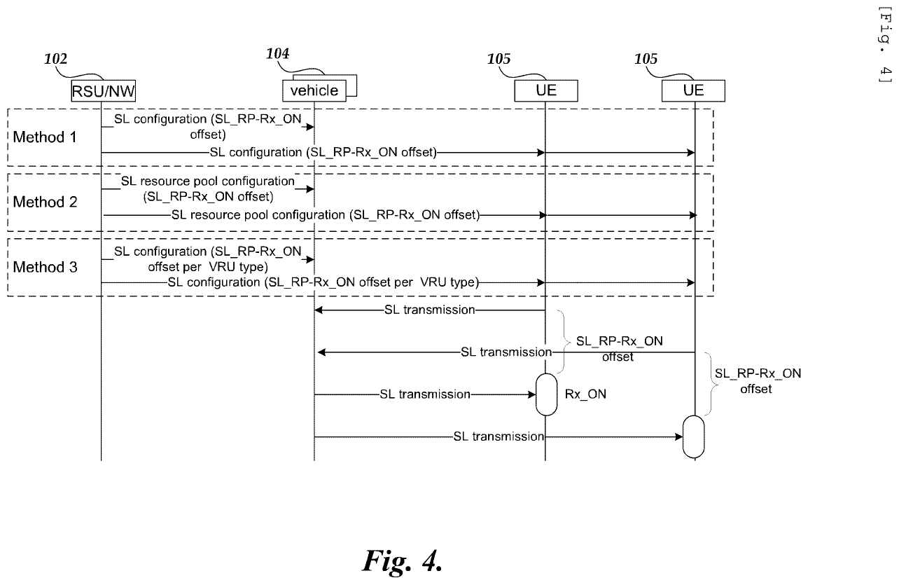

FIG. 4 is a block diagram of the architecture of FIG. 1 illustrating the configuration of PRS signal(s) in accordance with sidelink-based communications. As previously described, in accordance with a second embodiment, instead of static SL-RP_Rx-ON (pre-)configuration(s) on per SL resource pool basis as in the first embodiment, the SL-RP_Rx-ON related (pre-)configuration may indicate the offset between SL transmission of energy limited device(s) (e.g., periodic SL transmission of VRU devices' CAM or DEMN messages) and SL-RP Rx-ON time. Based on the SL-RP_Rx-ON offset (pre-)configuration, power limited device wakes up for SL reception after the (pre-)configured offset time (e.g., timing offset information) when it transmits the SL communication (e.g., CAM or DEMN message). Variations of this embodiment are described below.

Method 1: In this variation, the RSU 102/gNB 110 or other infrastructure equipment or pre-configuration may provide offset information (e.g., timing offset) in the form of a common SL-RP_Rx-ON offset configuration. The (pre-)configuration information may be received or be common to a subset of all user equipment, such as user equipment in the second set of user equipment. This offset may be specified regardless which SL resource pool is used for SL transmission and reception or regardless which group or type of SL devices are involved in SL ranging and positioning services.

Method 2: In this variation, the RSU 102/gNB 110 or pre-configuration may configure SL-RP_Rx-ON offset configuration on per resource pool specific. Illustratively, the timing offset information may be configured or pre-configured to each SL Tx resource pool. When energy limited device 105 makes SL transmission using resources of one SL Tx resource pool, the energy limited device needs to wake up to monitor the corresponding SL Rx resource pool (assuming there is one-to-one or many to one mapping between Tx resource pool to Rx resource pool) after (pre-)configured offset time when the energy/power limited device makes the SL transmission. The other device(s), such as UE(s) 104, can derive which SL Tx resource pool that energy limited device is using based on the resource from which the SL transmission is received. Therefore, the same offset of the derived Tx resource pool can be used by other device(s) to determine when to send SL ranging and positioning related transmissions to the energy/power limited device(s).

Method 3: In this variation, the RSU 102/gNB 110 or pre-configuration may configure SL-RP_Rx-ON offset configuration for certain type or group of the energy limited device(s). The type or group of the energy limited device(s) may be identified by a UE identifier, such as by a SL L1/L2 destination ID. In another example, the type or group may be identified by the QoS profile that the energy limited device(s) is/are used to transmit SL ranging and positioning related information or an explicit identifier of the power limited devices type or group. If UE identifier or QoS profile is used for association with the (pre-)configuration of the SL-RP_Rx-ON offset, both power limited device(s) and the other device(s) can derive the same offset based on the information utilized in the identification. If other identifier is used to identify the power limited devices type or group, the SL transmission from power limited device(s) should indicate the device type or group explicitly in order to allow the other device(s) to derive the same offset. In another illustrative example, the type or group of energy limited device(s) may be identified by one or more characteristic(s) or attribute(s) of the device(s). Such attribute(s) can include, but are not limited to, hardware configurations, software configurations, manufacturer, service provider, measured performance parameters, client identifiers, and/or role identifier(s), and the like.

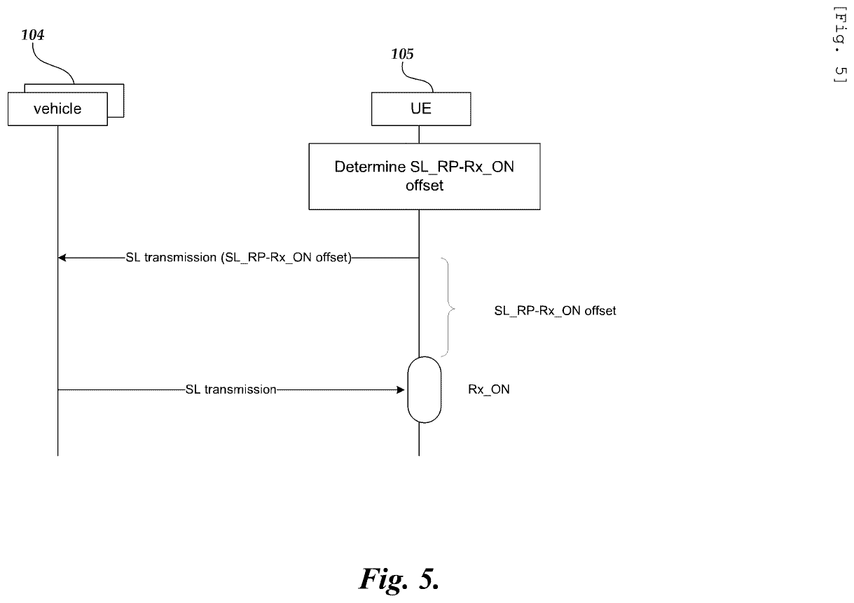

FIG. 5 is a block diagram of the architecture of FIG. 1 illustrating the configuration of PRS signals in accordance with sidelink-based communications. As previously described, in accordance with a third embodiment, instead of (pre-)configured SL-RP_Rx-ON offset configuration as illustrated in FIG. 4, the power limited device(s), e.g., user equipment 105 in the second set of user equipment, may indicate the offset of SL-RP_Rx-ON time in the SL transmission. That is power limited device(s) indicate the offset of wake-up time for SL reception towards its current SL transmission.

Illustratively, the timing offset information can be determined by each of the power limited device(s) depending on various criteria. For example, the user equipment can process one or more of the following criterion/criteria (individually or in combination), namely, the SL resource usage status, the rough distance/range between the power limited device(s) and other device(s), the QoS of SL ranging and positioning related information, the type or group of power limited device(s), the battery status etc. Upon determining the offset, the power limited device(s) may indicate the determined offset in its own SL transmission using either SL unicast or groupcast or broadcast. The offset can be either explicitly indicated in e.g., 1st stage SCI or 2nd stage SCI or MAC CE or information in PSFCH or a part of SL data payload.

Illustratively, one of the reserved resources may not be used to indicate the reserved resource for SL retransmission from the power limited devices. Instead, it is used to indicate the wake-up for SL reception (i.e., SL-RP Rx-ON time) by the power limited device(s). In order to differentiate these two different usages of future resource reservation information element in the SCI of current SL transmission, the energy limited device(s) need(s) to indicate whether the next reserved resources are for transmission or reception. If the reserved resources are indicated for reception, the resource may only include the time domain information and it's up to the other SL device(s) to select or be scheduled for SL resources in frequency domain. Or both time and frequency domain resources may be indicated by the power limited devices so that the power limited device(s) can wake up to only receive the SL transmission using the indicated time and frequency domain resources.

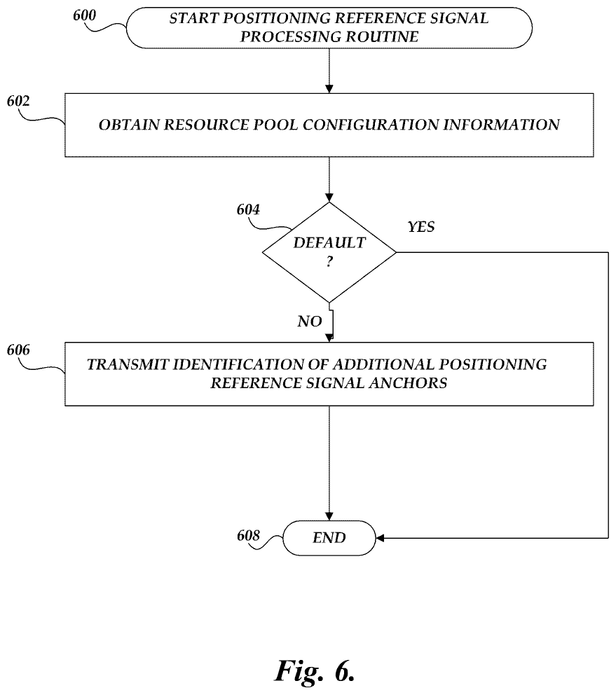

Turning now to FIG. 6, a routine 600 for positioning reference signal activation will be described. Aspects of routine 600 will be implemented by a user equipment that may determine between a default parameter for PRS transmission(s) or select from one or more alternative parameter(s). Illustratively, the parameter corresponds to a power-on parameter as discussed above with regard to FIG. 3B. As described above, in some embodiments, the RSU 102/gNB 110 or pre-configuration may configure multiple power-on parameters such that one or more UE(s) 104 may activate alternative power-on parameters based on criterion/criteria. At block 602, the user equipment may be (pre-)configured in the corresponding SL Tx resource pool configuration (assuming there is one-to-one or many-to-one mapping between SL Tx resource pool(s) and Rx resource pool) the aligned SL-RP_Rx-ON time related parameter(s).

At decision block 604, a test can be conducted to determine whether to use the default parameter(s). In case of multiple SL-RP_Rx-ON parameter set (pre-)configuration, the activation of other SL-RP_Rx-ON may be initiated either by other relevant device(s) (e.g., UE(s) 104) or by the power limited device(s) (e.g., UE(s) 105) based on detection of congestion in the default Rx-ON period or detection of the distance/range related trigger(s). In one example, the other device(s) may detect congestion of vehicles/UEs during the default Rx-ON period. The detection of congestion may be illustratively based on SL sensing result or SL CBR measurement. Based on application of threshold(s) or other information, the other device(s) may be configured with process rule(s) or selection criterion/criteria that determines when to select an alternative power-on parameter(s) and/or what alternative power-on parameter(s) to select. In another example, the other device may detect that the distance and/or range towards the energy limited device(s) becomes shorter. In this example, the other device(s) may trigger the activation of additional SL-RP_Rx-ON configuration to the power limited device(s), such as by application of thresholds for individual UE(s) 105, types of UEs, grouping of UEs, and the like.

If the default configuration is used, no action is considered and routine 600 terminates. Alternatively, at block 606, the other device(s), such as UE(s) 104, may provide an activation indication that can be transmitted together with SL transmission, that the other device(s) send to the power limited device(s) in the default Rx-ON period. In either case, the activation indication may be specified using either 1st stage SCI or 2nd stage SCI or MAC CE or information in PSFCH or a part of SL data payload to indicate also which SL-RP_Rx-ON parameter set is to be activated. The activation indication may be transmitted either using SL unicast or SL groupcast or broadcast. Routine 600 terminates at block 608.

Any embodiment (two or more) described in this disclosure may be used in combination. This combination may make use of logical “or”, “and”, and/or “exclusive or” between any embodiment.

Although the example of 5G NR was used in this disclosure, other Radio Access Technologies or Networks are possible, such as LTE, or 3GPP 6G. Other systems are possible, such as IEEE 802.11 and its derivatives, Wi-Fi, WiMAX, etc.

Clause 1 A method for using a user equipment in a sidelink communication, the method comprising: waking up the user equipment by a configuration or pre-configuration of one or more power-on parameters of the user equipment, wherein the one or more power-on parameters are utilized for performing sidelink communications with one or more additional user equipment, and wherein the one or more power-on parameters include a default time for waking up that is predetermined by the user equipment and at least one additional time for waking up based on a determination by the user equipment or a request by the one or more additional user equipment; and after waking up the user equipment, receiving, by the user equipment, one or more sidelink signals from the one or more additional user equipment.

Clause 2 The method as recited in Clause 1, wherein an activation of the at least one additional time for waking up is triggered based on an expected congestion at the default time or a distance between the user equipment and the one or more additional user equipment detected by the user equipment or by the one or more additional user equipment.

Clause 3 The method as recited in Clause 2, wherein the activation of the at least one additional time for waking up is communicated between the user equipment and the one or more additional user equipment via a sidelink unicast, or a sidelink groupcast or a sidelink broadcast.

Clause 4 The method as recited in Clause 1, wherein the one or more additional user equipment is configured to transmit the one or more sidelink signals to the user equipment at a time corresponding to the default time or the at least one additional time.

Clause 5 The method as recited in Clause 1, wherein the user equipment includes a mapping table indicating a one-to-one or a many-to-one correspondence between the default time and the at least one additional time for the user equipment to wake up and at least one transmission time at which the one or more additional user equipment transmit the one or more sidelink signals.

Clause 6 The method as recited in Clause 1, wherein the default time and the at least one additional time are time offsets from a transmission time at which a sidelink signal is transmitted from the user equipment.

Clause 7 The method as recited in Clause 6, wherein the time offsets are indicated through at least one of a Sidelink Control Information (SCI) based transmission, resource reservation information based transmission, or a medium access control (MAC) control element (CE) based transmission, from the user equipment or the one or more additional user equipment.

Clause 8 The method as recited in Clause 6, wherein time offsets are configured based on a quality of service profile of the user equipment.

Clause 9 An apparatus for use in a sidelink communication, the apparatus comprising:
a memory storing an instruction; and
a processor configured to execute the instruction stored in the memory to:
wake up the apparatus by a configuration or pre-configuration of one or more power-on parameters of the apparatus, wherein the one or more power-on parameters are utilized for performing sidelink communications with one or more additional apparatuses, and wherein the one or more power-on parameters include a default time for waking up that is predetermined by the apparatus and at least one additional time for waking up based on a determination by the apparatus or a request by the one or more apparatuses; and
after waking up the apparatus, receiving, by the apparatus, one or more sidelink signals from the one or more additional apparatuses.

Clause 10 The apparatus as recited in Clause 9, wherein an activation of the at least one additional time for waking up is triggered based on an expected congestion at the default time or a distance between the apparatus and the one or more additional apparatuses detected by the apparatus or by the one or more additional apparatuses.

Clause 11 The apparatus as recited in Clause 10, wherein the activation of the at least one additional time for waking up is communicated between the apparatus and the one or more additional apparatuses via a sidelink unicast, or a sidelink groupcast or a sidelink broadcast.

Clause 12 The apparatus as recited in Clause 9, wherein the one or more additional apparatuses is configured to transmit the one or more sidelink signals to the apparatus at a time corresponding to the default time or the at least one additional time.

Clause 13 The apparatus as recited in Clause 9, wherein the apparatus includes a mapping table indicating a one-to-one or a many-to-one correspondence between the default time and the at least one additional time for the apparatus to wake up and at least one transmission time at which the one or more additional apparatuses transmit the one or more sidelink signals.

Clause 14 The apparatus as recited in Clause 9, wherein the default time and the at least one additional time are time offsets from a transmission time at which a sidelink signal is transmitted from the apparatus.

Clause 15 The apparatus as recited in Clause 14, wherein time offsets are configured based on a quality of service profile of the apparatus.

Clause 16 A non-transitory computer-readable medium storing instructions that are executable by one or more processors of an apparatus to perform a method, the method comprising:
waking up the apparatus by a configuration or preconfiguration of one or more power-on parameters of the apparatus, wherein the one or more power-on parameters are utilized for performing sidelink communications with one or more additional apparatuses, and wherein the one or more power-on parameters include a default time for waking up that is predetermined by the apparatus and at least one additional time for waking up based on a determination by the apparatus or a request by the one or more apparatuses; and
after waking up the apparatus, receiving, by the apparatus, one or more sidelink signals from the one or more additional apparatuses.

Clause 17 A method for using a network infrastructure device in a sidelink communication, the method comprising:
configuring, by the network infrastructure device, one or more power-on parameters for one or more user equipment; and
transmitting, by the network infrastructure device, the one or more power-on parameters to the at least one user equipment,
wherein the one or more power-on parameters are utilized for waking up the one or more user equipment to receive sidelink signals from one or more additional user equipment.

Clause 18 The method as recited in Clause 17, wherein the network infrastructure device comprises at least one base station for use in the sidelink communication.

Clause 19 The method as recited in Clause 17, wherein the one or more power-on parameters include a default time for waking up the one or more user equipment and at least one additional time for waking up the one or more user equipment.

Clause 20 The method as recited in Clause 19, wherein an activation of the at least one additional time for waking up the one or more user equipment is triggered based on a congestion at the default time or a distance between the one or more user equipment and one or more additional user equipment detected by the user equipment or by the one or more additional user equipment.

Clause 21 The method as recited in Clause 20, wherein the one or more additional user equipment is configured to transmit the one or more sidelink signals to the one or more user equipment at a time corresponding to the default time or the at least one additional time.

Clause 22 The method as recited in Clause 21, wherein the network infrastructure device comprises a mapping table indicating a one-to-one or a many-to-one correspondence between the one or more power-on parameters for the one or more user equipment and one or more transmission times at which the one or more additional user equipment transmit the one or more sidelink signals.

Clause 23 The method as recited in Clause 19, wherein the default time and the at least one additional time are time offsets from a transmission time at which a sidelink signal is transmitted from the one or more user equipment.

Clause 24 The method as recited in Clause 23, wherein the one or more user equipment comprises a plurality of user equipment and the network infrastructure device configures same power-on parameters for the plurality of user equipment.

Clause 25 The method as recited in Clause 23, wherein the one or more user equipment comprises a plurality of user equipment and the network infrastructure device configures a plurality of different power-on parameters for the plurality of user equipment based on the identifiers of the plurality of user equipment.

Clause 26 The method as recited in Clause 23, wherein the one or more user equipment comprises a plurality of user equipment and the network infrastructure device configures a plurality of different power-on parameters for the plurality of user equipment based on types of the plurality of user equipment.

Clause 27 A network infrastructure device for use in a sidelink communication, the network infrastructure device comprising:
a memory storing an instruction; and
a processor configured to execute the instruction stored in the memory to:
configure, by the network infrastructure device, one or more power-on parameters for one or more user equipment; and
transmit, by the network infrastructure device, the one or more power-on parameters to the at least one user equipment,
wherein the one or more power-on parameters are utilized for waking up the one or more user equipment to receive sidelink signals from one or more additional user equipment.

Clause 28 The network infrastructure device as recited in Clause 27, wherein the network infrastructure device comprises at least one base station for use in the sidelink communication.

Clause 29 The network infrastructure device as recited in Clause 27, wherein the one or more power-on parameters include a default time for waking up the one or more user equipment and at least one additional time for waking up the one or more user equipment.

Clause 30 The network infrastructure device as recited in Clause 29, wherein an activation of the at least one additional time for waking up the one or more user equipment is triggered based on a congestion at the default time or a distance between the one or more user equipment and one or more additional user equipment detected by the user equipment or by the one or more additional user equipment.

Clause 31 The network infrastructure device as recited in Clause 29, wherein the one or more additional user equipment is configured to transmit the one or more sidelink signals to the one or more user equipment at a time corresponding to the default time or the at least one additional time.

Clause 32 The network infrastructure device as recited in Clause 31, wherein the network infrastructure device comprises a mapping table indicating a one-to-one or a many-to-one correspondence between the one or more power-on parameters for the one or more user equipment and one or more transmission times at which the one or more additional user equipment transmit the one or more sidelink signals.

Clause 33 The network infrastructure device as recited in Clause 29, wherein the default time and the at least one additional time are time offsets from a transmission time at which a sidelink signal is transmitted from the one or more user equipment.

Clause 34 The network infrastructure device as recited in Clause 33, wherein the one or more user equipment comprises a plurality of user equipment and the network infrastructure device configures same power-on parameters for the plurality of user equipment.

Clause 35 The network infrastructure device as recited in Clause 33, wherein the one or more user equipment comprises a plurality of user equipment and the network infrastructure device configures a plurality of different power-on parameters for the plurality of user equipment based on identifiers of the plurality of user equipment.

Clause 36 The network infrastructure device as recited in Clause 33, wherein the one or more user equipment comprises a plurality of user equipment and the network infrastructure device configures a plurality of different power-on parameters for the plurality of user equipment based on types of the plurality of user equipment.

Clause 37 A non-transitory computer-readable medium storing instructions that are executable by one or more processors of a network infrastructure device to perform a method, the method comprising:
configuring, by the network infrastructure device, one or more power-on parameters for one or more user equipment; and
transmitting, by the network infrastructure device, the one or more power-on parameters to the at least one user equipment,
wherein the one or more power-on parameters are utilized for waking up the one or more user equipment to receive sidelink signals from one or more additional user equipment.

Clause 38 A method for using an anchor device in a sidelink communication, the method comprising: obtaining, by the anchor device, one or more power-on parameters to wake up one or more user equipment, wherein the one or more power-on parameters include a default time for waking up and at least one additional time for waking up obtained by the anchor device, and wherein obtaining the one or more power-on parameters by the anchor device comprises receiving the one or more power-on parameters by the anchor device from a network infrastructure device or pre-configuring the one or more power-on parameters by the anchor device; and transmitting, by the anchor device, according to the obtained one or more power-on parameters, sidelink signals to the one or more user equipment.

Clause 39 The method as recited in Clause 38, wherein the method further includes: transmitting, by the anchor device, the obtained one or more power-on parameters to the one or more user equipment.

Clause 40 The method as recited in Clause 39, wherein the anchor device transmits the at least one additional time for waking up included in the one or more power-on parameters based on a determination of an expected congestion at the default time for waking up or a distance between the anchor device and the one or more user equipment detected by the anchor device.

Clause 41 The method as recited in Clause 38, wherein an activation of the at least one additional time for waking up is triggered based on a congestion at the default time or a distance between the one or more user equipment and one or more additional user equipment detected by the anchor device or by the one or more user equipment.

Clause 42 The method as recited in Clause 38, wherein the default time and the at least one additional time are time offsets from a transmission time at which a sidelink signal is transmitted from the one or more user equipment.

Clause 43 The method as recited in Clause 42, wherein the time offsets are determined based on at least one of: a sidelink resource usage status, an estimated distance between the one or more user equipment and another device, a quality of service of sidelink ranging and positioning related information, a type of the one or more user equipment, a battery status of the one or more user equipment.

Clause 44 The method as recited in Clause 42, wherein the time offsets are indicated through at least one of a Sidelink Control Information (SCI) based transmission, resource reservation information based transmission, or a medium access control (MAC) control element (CE) based transmission, from the user equipment or the one or more additional user equipment.

Clause 45 An anchor device for use in a sidelink communication, the anchor device comprising:
a memory storing an instruction; and
a processor configured to execute the instruction stored in the memory to:
obtain, by the anchor device, one or more power-on parameters to wake up one or more user equipment,
wherein the one or more power-on parameters include a default time for waking up and at least one additional time for waking up obtained by the anchor device, and
wherein obtaining the one or more power-on parameters by the anchor device comprises receiving the one or more power-on parameters by the anchor device from a network infrastructure device or pre-configuring the one or more power-on parameters by the anchor device; and
transmit, by the anchor device, according to the obtained one or more power-on parameters, sidelink signals to the one or more user equipment.

Clause 46 The anchor device as recited in Clause 45, wherein the processor is further configured to: transmit the obtained one or more power-on parameters to the one or more user equipment.

Clause 47 The anchor device as recited in Clause 46, wherein the anchor device transmits the obtained additional time for waking up based on a determination of an expected congestion at the default time for waking up or a distance between the anchor device and the one or more user equipment detected by the anchor device.

Clause 48 The anchor device as recited in Clause 45, wherein an activation of the at least one additional time for waking up the one or more user equipment is triggered based on a congestion at the default time or a distance between the one or more user equipment and one or more additional user equipment detected by the anchor device or by the one or more user equipment.

Clause 49 The anchor device as recited in Clause 45, wherein the default time and the at least one additional time are time offsets from a transmission time at which a sidelink signal is transmitted from the one or more user equipment.

Clause 50 The anchor device as recited in Clause 49, wherein the time offsets are determined based on at least one of: a sidelink resource usage status, an estimated distance between the one or more user equipment and another device, a quality of service of sidelink ranging and positioning related information, a type of the one or more user equipment, or a battery status of the one or more user equipment.

Clause 51 The anchor device as recited in Clause 49, wherein the offsets are reserved resources included in an initial sidelink transmission, and wherein the reserved resources include at least one of a time resource or a frequency resource.

Clause 52 A non-transitory computer-readable medium storing instructions that are executable by one or more processors of an anchor device to perform a method, the method comprising:
obtaining, by the anchor device, one or more power-on parameters to wake up one or more user equipment,
wherein the one or more power-on parameters include a default time for waking up and at least one additional time for waking up obtained by the anchor device, and
wherein obtaining the one or more power-on parameters by the anchor device comprises receiving the one or more power-on parameters by the anchor device from a network infrastructure device or pre-configuring the one or more power-on parameters by the anchor device; and
transmitting, by the anchor device, according to the obtained one or more power-on parameters, sidelink signals to the one or more user equipment.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be fully automated via software code modules, including one or more specific computer-executable instructions executed by a computing system. The computing system may include one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might,” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art. Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

This application claims the benefit of U.S. Provisional Application No. 63/335,601, entitled SL RANGING AND POSITIONING SPECIFIC RX-ON TIME FOR POWER LIMITED DEVICES, and filed on Apr. 27, 2022. U.S. Provisional Application No. 63/335,601 is incorporated in its entirety by reference herein.

1. A method for using a user equipment in a sidelink communication, the method comprising:
waking up the user equipment by a configuration or pre-configuration of one or more power-on parameters of the user equipment, wherein the one or more power-on parameters are utilized for performing sidelink communications with one or more additional user equipment, and wherein the one or more power-on parameters include a default time for waking up that is predetermined by the user equipment and at least one additional time for waking up based on a determination by the user equipment or a request by the one or more additional user equipment; and
after waking up the user equipment, receiving, by the user equipment, one or more sidelink signals from the one or more additional user equipment.

2. The method as recited in claim 1, wherein an activation of the at least one additional time for waking up is triggered based on an expected congestion at the default time or a distance between the user equipment and the one or more additional user equipment detected by the user equipment or by the one or more additional user equipment.

3. The method as recited in claim 2, wherein the activation of the at least one additional time for waking up is communicated between the user equipment and the one or more additional user equipment via a sidelink unicast, or a sidelink groupcast or a sidelink broadcast.

4. The method as recited in claim 1, wherein the one or more additional user equipment is configured to transmit the one or more sidelink signals to the user equipment at a time corresponding to the default time or the at least one additional time.

5. The method as recited in claim 1, wherein the user equipment includes a mapping table indicating a one-to-one or a many-to-one correspondence between the default time and the at least one additional time for the user equipment to wake up and at least one transmission time at which the one or more additional user equipment transmit the one or more sidelink signals.

6. The method as recited in claim 1, wherein the default time and the at least one additional time are time offsets from a transmission time at which a sidelink signal is transmitted from the user equipment.

7. The method as recited in claim 6, wherein the time offsets are indicated through at least one of a Sidelink Control Information (SCI) based transmission, resource reservation information based transmission, or a medium access control (MAC) control element (CE) based transmission, from the user equipment or the one or more additional user equipment.

8. The method as recited in claim 6, wherein the time offsets are configured based on a quality of service profile of the user equipment.

9-16. (canceled)

17. A method for using a network infrastructure device in a sidelink communication, the method comprising:
configuring, by the network infrastructure device, one or more power-on parameters for one or more user equipment; and
transmitting, by the network infrastructure device, the one or more power-on parameters to the at least one user equipment,
wherein the one or more power-on parameters are utilized for waking up the one or more user equipment to receive sidelink signals from one or more additional user equipment.

18. The method as recited in claim 17, wherein the network infrastructure device comprises at least one base station for use in the sidelink communication.

19. The method as recited in claim 17, wherein the one or more power-on parameters include a default time for waking up the one or more user equipment and at least one additional time for waking up the one or more user equipment.

20. The method as recited in claim 19, wherein an activation of the at least one additional time for waking up the one or more user equipment is triggered based on a congestion at the default time or a distance between the one or more user equipment and one or more additional user equipment detected by the user equipment or by the one or more additional user equipment.

21. The method as recited in claim 20, wherein the one or more additional user equipment is configured to transmit the one or more sidelink signals to the one or more user equipment at a time corresponding to the default time or the at least one additional time.

22. The method as recited in claim 21, wherein the network infrastructure device comprises a mapping table indicating a one-to-one or a many-to-one correspondence between the one or more power-on parameters for the one or more user equipment and one or more transmission times at which the one or more additional user equipment transmit the one or more sidelink signals.

23. The method as recited in claim 19, wherein the default time and the at least one additional time are time offsets from a transmission time at which a sidelink signal is transmitted from the one or more user equipment.

24-37. (canceled)

38. A method for using an anchor device in a sidelink communication, the method comprising:
obtaining, by the anchor device, one or more power-on parameters to wake up one or more user equipment,
wherein the one or more power-on parameters include a default time for waking up and at least one additional time for waking up obtained by the anchor device, and
wherein obtaining the one or more power-on parameters by the anchor device comprises receiving the one or more power-on parameters by the anchor device from a network infrastructure device or pre-configuring the one or more power-on parameters by the anchor device; and
transmitting, by the anchor device, according to the obtained one or more power-on parameters, sidelink signals to the one or more user equipment.

39. The method as recited in claim 38, wherein the method further comprises: transmitting, by the anchor device, the obtained one or more power-on parameters to the one or more user equipment.

40. The method as recited in claim 39, wherein the anchor device transmits the at least one additional time for waking up included in the one or more power-on parameters based on a determination of an expected congestion at the default time for waking up or a distance between the anchor device and the one or more user equipment detected by the anchor device.

41. The method as recited in claim 38, wherein an activation of the at least one additional time for waking up is triggered based on a congestion at the default time or a distance between the one or more user equipment and one or more additional user equipment detected by the anchor device or by the one or more user equipment.

42. The method as recited in claim 38, wherein the default time and the at least one additional time are time offsets from a transmission time at which a sidelink signal is transmitted from the one or more user equipment.

43-52. (canceled)
